(19) United States
(12) Patent Application Publication
(10) Pub. No.: US 2005/0210797 A1
(43) Pub. Date: Sep. 29, 2005

(54) Door assembly

(76) Inventor: David G. Hees, Ada, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 10/801,025

(22) Filed: Mar. 15, 2004

Related U.S. Application Data
(60) Provisional application No. 60/455,287, filed on Mar. 17, 2003.

(51) Int. Cl. E06B 3/70

(52) U.S. Cl. 52/455; 52/656.4

(57) ABSTRACT

A door assembly of the present invention is assembled from a pair of hollow core stiles and a pair of rails. A panel is inserted between and extended into the rails and the stiles. The stiles and the rails and the panel are then interconnected to form a stile and rail style door assembly.

This application claims priority from provisional application entitled DOOR ASSEMBLY, Ser. No. 60/455,287, filed Mar. 17, 2003, Attorney Docket KEN02 P-100, which is herein incorporated by reference in its entirety.

### TECHNICAL FIELD AND BACKGROUND OF INVENTION

The present invention relates to a door assembly and, more particularly, to a panel door assembly and to a method of making the panel door assembly.

Conventional doors typically fall into two categories: hollow core flat or flush panel doors or solid stile and rail doors. Hollow core panel doors have been typically far less costly to manufacture than solid stile and rail doors and are assembled from a perimeter frame with front and back decorative or door skins mounted over the frame to form the hollow core door. To provide support to the decorative skins, inserts are often provided between the skins with the inserts comprising, for example, cardboard inserts or foam inserts that provide rigidity to the door skins without adding significant weight to the door assembly. Current hollow core doors have been in existence since yearly 1960's. Until fairly recently, the entire surface of the standard hollow core door was smooth or flush.

Heretofore, stile and rail panel interior doors have been constracted from solid stiles and rails. Over the years, several stile and rail wood frame techniques have been attempted to reduce the costs of the solid door while achieving the desired stability. Some of these more recent techniques include providing a stile or rail formed from a wood substrate, such as a less dense wood, a composite, including medium density fiberboard (MDF), with glued wood face veneers.

More recently, hollow core doors have been introduced that resemble the appearance of a stile and rail door. Although these types of doors resemble a “stile and rail” door, they are still considered a flush door since the pattern is simply stamped onto the door skin, with the doors still constructed as hollow core doors.

Current tastes, however, demand more authentic looking stile and rail doors but without the added expence associated with them. Consequently, there is a need for a “stile and rail” style doot that is less costly to manufacture.

### SUMMARY OF THE INVENTION

Accordingly, the present invention provides a door assembly that incorporates elements of a hollow door and of a rail and stile door to produce a door assembly that it constructed similar to a rail and stile door that has the appearance of a rail and stile door but without the expense of a conventional rail and stile door.

The present invention relates to a method of forming a door assembly. The door is assembled from a pair of hollow core stiles and a pair of railsw. A panel is inserted between the rails and the stiles and extends into the rails and stiles. The stiles, rails, and the panel are then interconnected to form a paneled door assembly that has the appearance of a conventional “stile and rail” door.

In one aspect, the hollow core stiles are formed by assembling a sub-frame from a pair of generally horizontally spaced frame members and a pair of generally vertically spaced frame members. Door skins are attached to the front and back sides of the sub-frames to form the hollow core stiles. The rails are preferably interconnected with the stiles by fasteners, such as dowels. Furthermore, the panels are preferably attached to the sub-frames by adhesive bonding.

In other aspects, the rails also comprise hollow core rails and are similarly constructed to the stiles. The panel is inserted into grooves formed in the stiles and rails. For example, the grooves in the stiles are formed in the inwardly facing sides of the sub-frames of the respective stiles and rails.

According to another aspect of the invention, a door assembly includes a pair of stiles, with at least one of the stiles comprising a hollow core, a pair of rails interconnecting the stiles, and at least one panel extending into the stiles and rails and being supported between the pair of stiles and the pair of rails.

For example, the hollow core stile includes a pair of spaced apart generally vertical frame members, a pair of generally horizontal frame members interconnected with the vertical frame members to form a sub-frame, and door skins mounted over the sub-frame are secured to the sub-frame. Preferably, each of the stiles comprises a hollow core stile.

In yet another form, a paneled door assembly includes a pair of stiles, at least one of the stiles comprising a hollow core stile, a pair of rails interconnecting the stiles, with at least one of the rails comprising a hollow core rail, ant at least one panel extending into the stiles and rails and being supported between the pair of stiles and the pair of rails.

In can be appreciated from the foregoing that the present door assembly, therefore, provides the appearance of a stile and rail door without the expense associated with conventional solid stile and rail doors and with the ease of construction as a hollow panel door. These and other objects, advantages, purposes, and features of the invention will become more apparent from the study of the following description taken in conjunction with the drawings.

### BRIEF DESCRIPTION OF THE DRAWINGS

FIG. 1A is an elevation face view of a single panel style door assembly of the present invention;

FIG. 1B is an elevation face view of a two-panel style door assembly of the present invention;

FIG. 1C is an elevation face view of another embodiment of the door assembly of FIG. 1B;

FIG. 1D is an elevation face view of a three-panel style door assembly of the present invention;

FIG. 2 is an enlarged fragmentary elevation view of the door assembly illustrated in FIG. 1B;

FIG. 3 is a partial fragmentary view of one stile of the door assembly of FIG. 2;

FIG. 4 is a fragmentary view of a rail of the door assembly of FIG. 2;

FIG. 5 is a fragmentary view of an alternate embodiment of a top rail, such as the top rail of the door assembly in FIG. 1C;

FIG. 6 is an enlarged partial fragmentary view of the door assembly of the present invention illustrating the connection between the bottom rail and the left side stile of the door assembly of FIG. 2;

FIG. 7 is an exploded partial perspective view illustrating the connection between the bottom rail and the left side stile of the door assembly of FIG. 2;

FIG. 8 is a perspective view of an intermediate panel of the door assembly of FIG. 2 illustrating two panels assembled, such as by gluing to form a thicker panel;

FIG. 9 is a perspective view of another embodiment of an intermediate door panel of the door assembly of the present invention illustrating two panels assembled with a foam substrate to form a thicker panel;

FIG. 10 is a fragmentary elevation view of yet another embodiment of a door assembly of the present invention; and

FIG. 11 is an exploded enlarged perspective fragmentary view another method of assembling a door assembly of the present invention illustrating top or bottom slide-in panels.

### DETAILED DESCRIPTION OF THE PREFERRED EMBODIMENTS

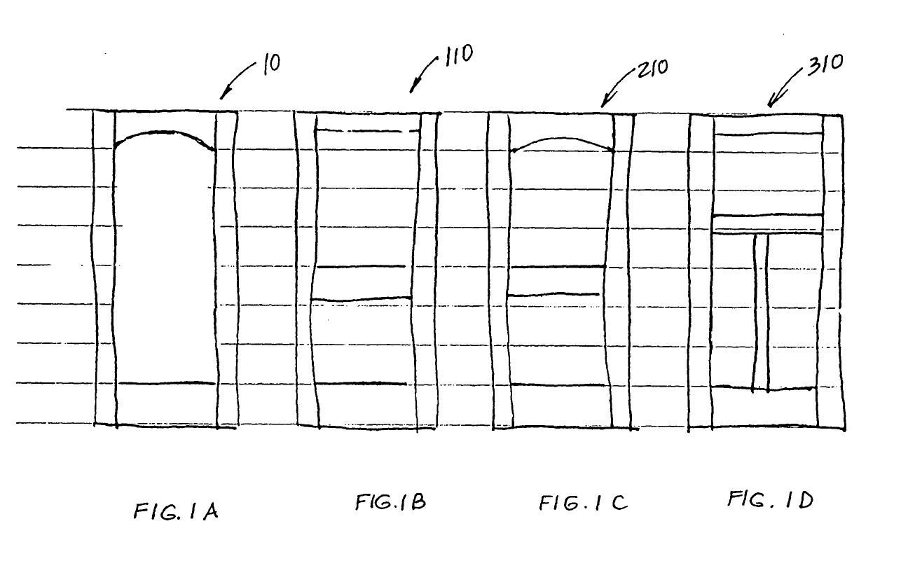

Referring to FIGS. 1A-1D, the numerals 10, 110, 210, and 310, respectively, designate various styles of the stile and rail door assembly of the present invention. Door assemblies 10, 110, 210, and 310 are assembled from similar components and in a manner to create the appearance of a “stile and rail” door. The doors are assembled using a combination of stile and rail door construction techniques and hollow door construction techniques to minimize the cost and weight of the door but without sacrificing the appearance of the door. As will be appreciated from the description which follows, the door assemblies of the present invention may be assembled with two or more stiles and two or more rails to create a desired panel effect of a traditional stile and rail door. For ease of description, initial reference will be made herein to door assembly 110, which forms a two-panel style door, though it should be understood that three, four, five, and six-panel style doors may be constructed using similar techniques and similar components.

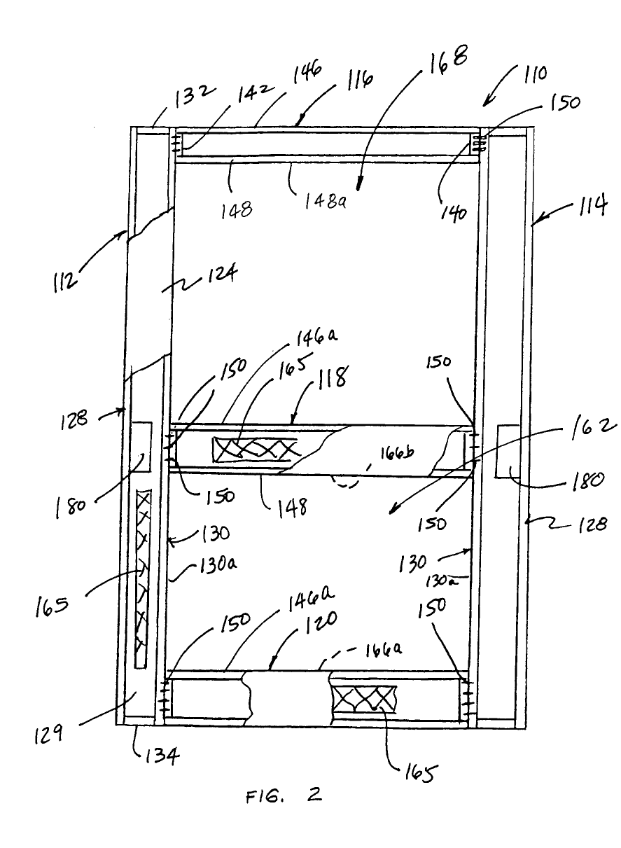

Referring to FIG. 2, door assembly 110 is assembled from a pair of generally vertical members or stiles 112 and 114 and upper intermediate and lower generally horizontal members or rails 116, 118, and 120. In preferred form, stiles 112 and 114 and rails 116, 118, and 120 are each similarly constructed from sub-frames and door skins, with the rails interconnected with the stiles using fasteners, such as wood dowels (142, 150).

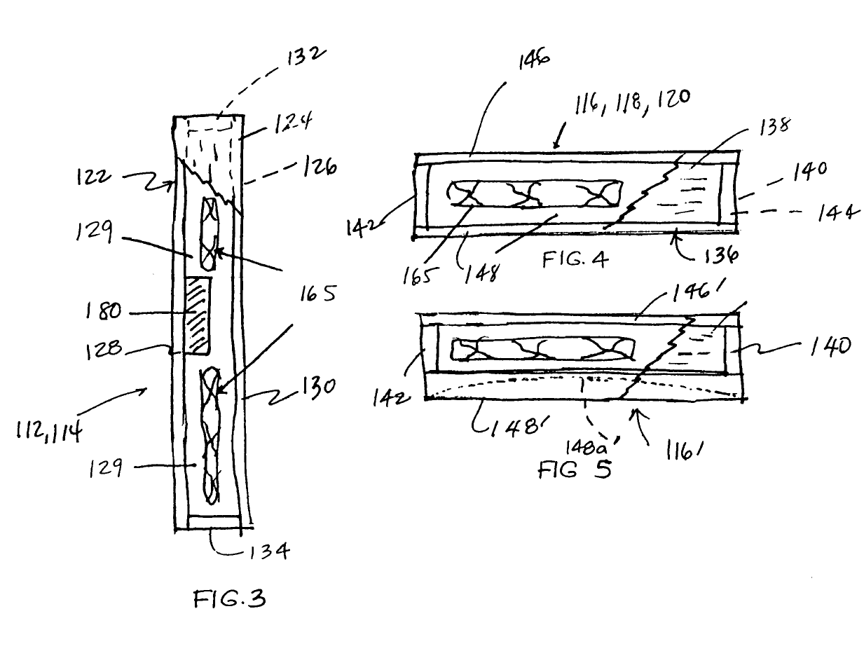

Referring to FIG. 3, each stile 112, 114 is assembled from a sub-frame 122 and a pair of door skins 124 and 126, which are mounted to the front and back sides of frame 122 to create a hollow core 129 and, further, to create the appearance of forming a solid wood stile. Sub-frame 122 is formed from spaced apart generally vertical frame members 128 and 130, which are interconnected by vertically spaced frame members 132 and 134. Sub-frame members 128, 130, 132, and 134 may be formed from solid wood or wood MDF members and are interconnected by glue and/or fasteners, such as dowels, nails, or the like. It should be understood that the members may be interconnected by a combination of glue and fasteners and, further, that the number of fasteners may vary depending on the application.

Door skins 124 and 126 are mounted over sub-frame 122 and attached thereto by, for example, an adhesive. Door skins 124 and 126, for example may comprise wood veneer panels, such as a wood cross-band, oak, birch, cherry, maple or the like, or may comprise a veneer over a substrate, such as MDF, or the like, and preferably have thicknesses in a range of about ½ inch to 1/32 inch and, more typically, in range of about ¼ inch to ⅛ inch and, most typically, about ⅛ inch.

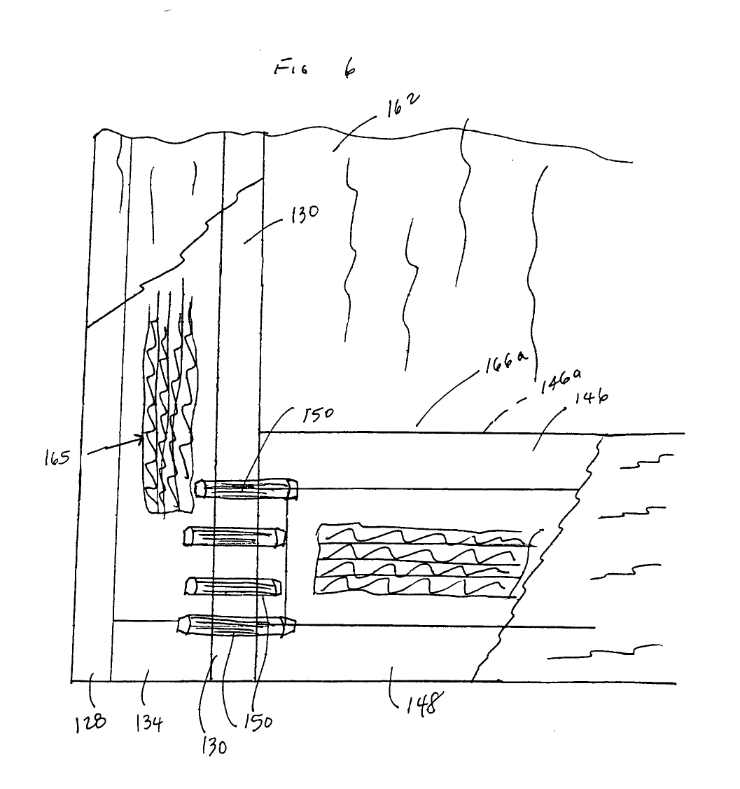

As best seen in FIG. 4, upper, intermediate and lower rails 116, 118, and 120 are similarly formed from a sub-frame 136 and a pair of door skins 138 and 140 which are mounted over sub-frame 136 and attached thereto by an adhesive or the like, which are similar to skins 124 and 126. Sub-frame 136 is similarly formed from a pair of horizontally spaced generally vertical frame members 142 and 144 and a pair of vertically spaced generally horizontal frame members 146 and 148. Frame members 142, 144, 146, and 148 are similarly interconnected by glue, nails, dowels or other suitable fastening methods. In the illustrated embodiment, intermediate and lower rails 118 and 120 have a greater height dimension than upper rail 116; however, it may be appreciated that all the rails may have different heights or rails 116, 118, 120 may have commensurate heights.

Referring again to FIG. 2, as noted above rails 116, 118, and 120 are interconnected with the generally vertical frame members 128 and 130 of the respective stiles, for example, by fasteners, such as dowels 150, which are inserted into mounting openings formed in the respective vertical frame members of the stiles 112 and 114 and vertical frame members 142, 140 of the respective rails. The number of dowels may be varied depending the height of the rails.

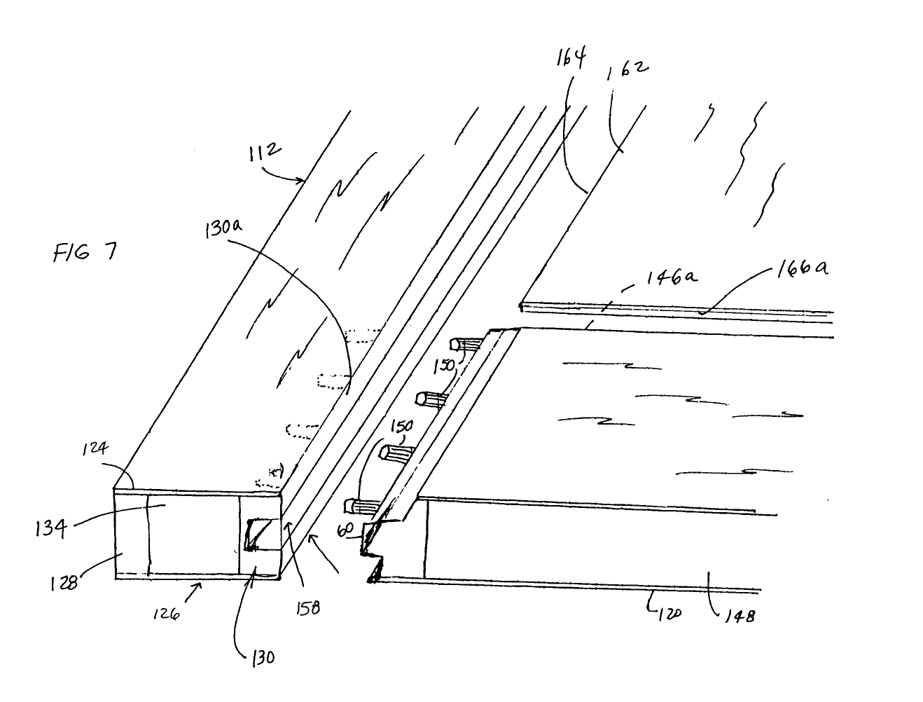

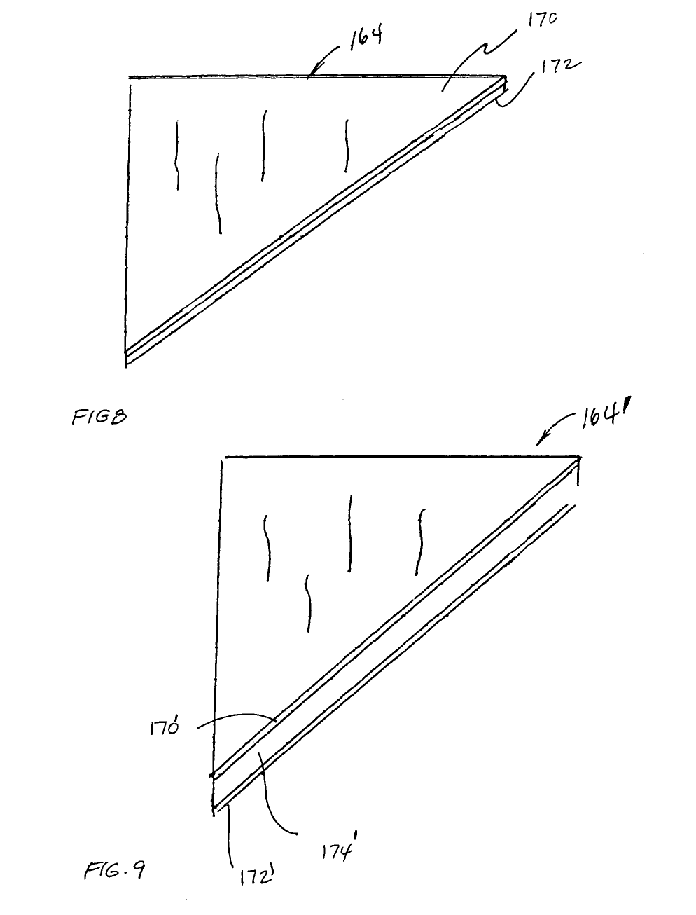

Referring to FIGS. 6 and 7, the inwardly facing side 130a of vertical frame member 130 of the respective stile includes a longitudinal groove 158 formed therein for receiving a corresponding projecting rib or flange 160 formed on the respective horizontal rail and, further, for receiving an intermediate door panel 162. Similarly, the inwardly facing sides 146a and 148a of frame members 146 and 148 of the horizontal rails similarly include elongated grooves for receiving the lower and upper edges 166a and 166b of panel 162. Though illustrated in reference to the left stile and lower rail, it should be understood that a similar construction is used between intermediate panel 162 and stile 114 and rails 118 and, further, between an upper intermediate panel 168 and stiles 112, 114 and rails 116 and 118. In this manner, when assembled, door 110 has the appearance of a two-panel stile and rail door assembly is assembled using hollow panel door components. Preferably, the elongated grooves formed in the inwardly facing frame members of the respective stiles and rails have an adhesive applied thereto before the insertion of the respective intermediate door panel to thereby secure the door panel in the respective stiles and rails. Furthermore, though illustrated with a “square sticking pattern”; other patterns, such as rounded patterns, including a quarter round, oval or the like, may be used. It should be understood that additional trim may be provided at the juncture of the intermediate door panels and the stiles or rails to provide further detailing to the door though this additional detail is not illustrated herein.

To increase the support for the door skins, door assembly 110 may include inserts, such as corrugated or honeycomb paper or cardboard inserts or foam, which are placed in between the door skins. The number, size and type of insert may be varied. Typically any suitable light weight material may be used. In addition, should a heavier door be desired, a more dense insert may be used, such as particle board or the like.

In addition, to provide local support to stiles 112, 114, for mounting hinges or door handles or locks, door assembly 110 may include blocks 180, such as wood blocks, which provide a mounting surface for the mounting hardware or lock set, which usually requires a bore to be machined through the door.

Referring to FIG. 5, it should be understood that the rails and also the stiles may be formed from non-rectilinear frame members, for example, to create an arch or the like. As best seen in FIG. 5, the upper rail 116′ is formed from space apart generally vertical frame members 140′, 142′ and upper and lower generally horizontal frame members 146′ and 148′, with frame member 148′ machined or formed with a lower edge 148a′ forming an arch.

It should be understood, that the other rails may be provided with frame members that also include an arched edge, such as shown in FIGS. 1A and 1C, to create yet a different style of door.

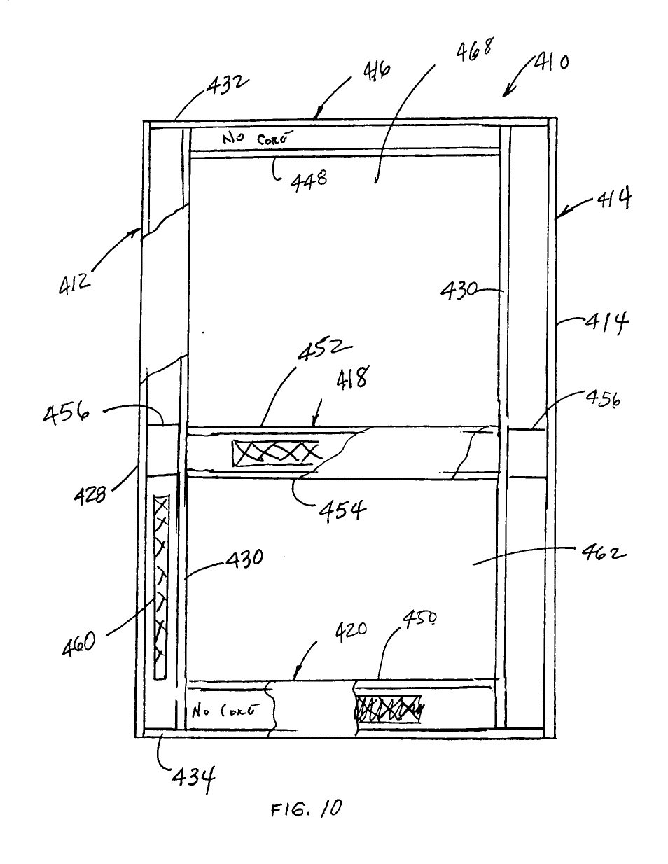

Referring to FIGS. 8 and 9, the intermediate door panels 162 and 168 are each formed from a pair of door skins 170 and 172, which are co-joined, for example by an adhesive. Typically, door skins 170 and 172 have an ⅛^{th} inch thickness to form an overall intermediate panel thickness of approximately ¼ of an inch. The door skins may be formed from a wood veneers or from an MDF cross band (in which a very thin veneer, for example on the order of less than 1/80^{th} of an inch, may be applied over the MDF) to give the appearance of a wood panel. Similarly, the door skins applied to the frames of the respective stiles and rails may be similarly formed from an MDF cross band to further reduce the cost of the door assembly. Further, while panels 162 and 168 are illustrated as flat panels, panels 162 and 168 may comprise raised panels, double hip panel, grooved panels, or panels with glass inserts. In addition, the panels may be pre-finished, with either a primer coated for painted doors or with a stain and polyurethane finish for example for wood doors. The doors skins forming the stiles and rails may be similar pre-finished.

Referring to FIG. 9, the thickness of the intermediate door panels may be increased to, for example, in a range of ¾ inch to ½ inch and may be formed from a combination of wood door skins and a layer of insulation 174′, such as a foam core 174′, which is sandwiched between door skins 170′ and 172′. Similarly, the door skins may be formed from wood veneers or MDF cross band (with wood veneers on the order of less than 1/80^{th} of an inch) to thereby further reduce the cost of the door. When a layer of insulation is added to panels 162 and 168, the insulation may provide increased damping and reduce the risk of the panels vibrating or rattling.

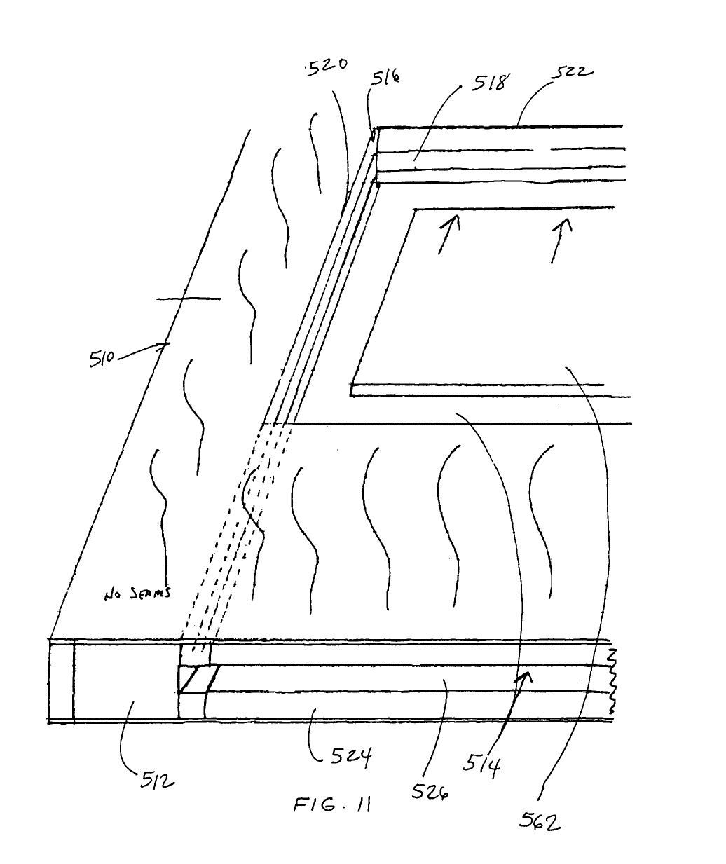

Referring to FIG. 10, the numeral 410 designates another embodiment of the door assembly of the present invention. Door assembly 410 is similarly constructed from a plurality of stiles 412, 414, and a plurality of rails 416, 418, and 420 and upper and lower intermediate door panels 462 and 468. Stile 412 is formed from generally horizontal vertical frame members 428 and 430 that are interconnected by upper and lower frame members 432 and 434, which span door 410 to form upper and lower rails 416 and 420 and, further, to interconnect the respective generally vertical frame members 430 and 428 of rail 414.

Rails 416 and 420 are formed by frame members 432 and 434, respectively, and, further, by horizontal frame members 448 and 450, which interconnect with generally vertical frame members 430 of stiles 412 and 414, for example by glue, nails, or other suitable fasteners. Intermediate rail 418 is constructed from a pair of generally horizontal frame members 452 and 454, which span between frame members 430 and 430 of stiles 412 and 414 and, further, are interconnected therewith, for example, by glue, which extend into the vertical frame members 430 of the respective stiles. It should be understood that other methods of attachment may also be used.

To provide additional support to the vertical frame members of stiles 412 and 414, each stile 412, 414 preferably includes a block 456, which may optionally provide a mounting surface for the horizontal members 452 and 454 of rail 418. Furthermore, blocks 456 provide a mounting surface for the respective door hardware, such as door latches or the like. As will be understood from FIG. 10, the respective stiles and rails include door skins that are adhered to the respective frame members forming the respective stiles and rails similar to the previous embodiments and, further, may include inserts, such as inserts 460, which provide support to the respective door skins, without the additional weight associated with solid wood constructed doors.

Referring to FIG. 11, another method of constructing a door assembly of the present invention includes providing a flat panel door assembly 510, which is formed from a perimeter frame 512, and cutting an opening 514, such as a central opening, in the door assembly. The opening is framed by a wood frame support 516 with a groove 518 formed therein along the frame's vertical edges 520 (only one shown) and horizontal edge 522 for receiving an intermediate panel 562, similar to the intermediate panels described in reference to the previous embodiments. The lower member 524 of frame 512 is formed with a transverse opening 526 for inserting intermediate panel 562 into the door and into grooves 518. Alternately, the intermediate panel may be inserted from the top member (not shown) of the frame 512. Where upper and lower intermediate panels are to be formed, the respective panels may be inserted from both ends of the door.

It should be understood from the foregoing, that the door of the present invention may be formed from wood veneers and may be pre-finished or may be formed from materials suitable for painting. Furthermore, the components forming the door may be stained, pre-finished, or primed before assembly. In the latter embodiment, the construction of the door eliminates the gaps that are associated with a stile and rail door, which is especially important when using a painted or primed finish. Furthermore, it should be appreciated that other sizes of doors may be formed using the method of the present invention. Furthermore, although described in reference to the 36 inch width door example, the door of the present invention may be assembled into various shapes and sizes without departing from the scope of the invention.

For example, for a 36 inch door, such as a birch door, the door may be constructed of two hollow core birch flush door panels that are manufactured so that they are 5 inches wide and 80 inches tall with a 1⅜ inch thickness, for example. A top rail will be formed from a 5 inch by 27 inch long hollow core flush door assembly again with a 1⅜ inch thickness. A bottom rail will be similarly manufactured from a 12 inch wide and a 27 inch long hollow core flush panel door assembly with a 1⅜ inch thickness. These stiles and rails will be trimmed and machined, with dowel holes drilled into the inwardly facing sides of the respective frame members of the rails and stiles. Furthermore, a groove, such as a ¼ or ½ inch groove, will be machined into the inwardly facing edges of the respective hollow door panels. Two birch plywood veneers will be glued back to back and formed into a panel, such as a ¼ inch or greater panel. The wood dowels will then be placed into the dowel holes of the stiles and rails. The birch panel will then be cut to size and fitted into the grooves cut into the stiles and rails, with the four stiles and rails clamped together and with the wood dowels extending into the respective dowel holes. It should be understood that other door thicknesses may be produced using the same method and, further, doors with different veneer thicknesses and interior panel thicknesses may be used. In addition, the width of the respective stiles and height of the respective rails may be adjusted to suit. It should be understood from the foregoing that the door assembly of the present invention may be constructed to form a single panel door style, such as shown in FIG. 1A, or multiple panel door styles, such as illustrated in FIGS. 1B-1D, including door assemblies that incorporate more than two stiles.

It can be appreciated that the method of manufacturing or assembling the door assembly of the present invention combines hollow core flush door assembly construction with stile and rail door construction to produce an authentic looking stile and rail door without the normal high expense associated with solid wood door construction.

While several forms of the invention have been shown and described, other forms will now be apparent to those skilled in the art. Therefore, it will be understood that the embodiments shown in the drawings and described above are merely for illustrative purposes, and are not intended to limit the scope of the invention, which is defined by the claims, which follow as interpreted under the principles of patent law including the doctrine of equivalents.

1. A method of forming a door assembly, said method comprising the steps of:
forming a pair of hollow core stiles;
forming a pair of rails;
inserting a panel between the rails and the stiles;
extending the panel into the rails and stiles; and
interconnecting the stiles and the rails and the panel to form a stile and rail style door assembly.

2. The method according to claim 1, wherein said forming a pair of hollow core stiles comprises:
assembling a sub-frame from a pair of generally horizontally spaced frame members and generally vertically spaced frame members;
attaching door skins to a first side of the sub-frame and to a second side of the sub-frame to form a hollow core stile; and
forming at least two of the hollow core stiles.

3. The method according to claim 2, wherein said assembling includes interconnecting the horizontally spaced frame members and the vertically spaced frame members with fasteners.

4. The method according to claim 3, wherein said interconnecting comprises interconnecting the horizontally spaced frame members and the vertically spaced frame members with dowels.

5. The method according to claim 4, wherein said attaching comprises adhesively bonding the door skins to the front and back sides of the sub-frame.

6. The method according to claim 1, wherein said forming a pair of rail comprises forming at least one hollow core rail.

7. The method according to claim 1, wherein said forming a pair of rail comprises forming a pair of hollow core rails.

8. The method according to claim 1, wherein said inserting a panel comprises forming a groove in said stiles and said rails and inserting said panel into said grooves.

9. The method according to claim 1, wherein said forming a groove in said stiles comprises forming a groove in an inwardly facing side of said sub-frame.

10. A paneled door assembly comprising:
a pair of stiles, at least one of said stiles comprising a hollow core;
a pair of rails interconnecting said stiles; and
at least one panel extending into said stiles and rails and being supported between said pair of stiles and said pair of rails.

11. The paneled door according to claim 10, wherein said at least one stile comprises:
a pair of spaced apart generally vertical frame members, a pair of generally horizontal frame members interconnected with said vertical frame members to form a sub-frame, and door skins mounted over said sub-frame and secured to said sub-frame.

12. The paneled door according to claim 11, wherein an inwardly facing sides of said sub-frame receives said panel therein.

13. The paneled door according to claim 12, wherein each of said stiles comprises hollow core stiles.

14. A paneled door assembly comprising:
a pair of stiles, at least one of said stiles comprising a hollow core;
a pair of rails interconnecting said stiles, at least one of said rails comprising a hollow core; and
at least one panel extending into said stiles and rails and being supported between said pair of stiles and said pair of rails.

15. The panel door assembly according to claim 14, wherein said at least one rail comprises a pair of spaced apart generally vertical frame members, a pair of generally horizontal frame members interconnected with said vertical frame members to form a sub-frame, and door skins mounted over said sub-frame and secured to said sub-frame, and an inwardly facing side of said sub-frame receiving said panel.

16. The panel door assembly according to claim 14, wherein said stiles are interconnect with said rails by fasteners.

17. The panel door assembly according to claim 14, wherein said fasteners comprise dowels.

18. A paneled door assembly comprising:
a pair of stiles;
a pair of rails interconnecting said stiles;
at least one panel supported between said pair of stiles and said pair of rails; and
each of said stiles comprising a pair of spaced apart generally vertical frame members, a pair of generally horizontal frame members interconnected with said vertical frame members to form a sub-frame, and door skins mounted over front and back sides of said sub-frame and secured to said sub-frame, and inwardly facing sides of said vertical frame members receiving said panel therein to thereby from said door assembly.

19. The paneled door assembly according to claim 18, wherein at least one of said rails comprises a pair of spaced apart generally vertical frame members, a pair of generally horizontal frame members interconnected with said vertical frame members of said rail to form a sub-frame, and door skins mounted over front and back sides of said sub-frame of said rail and secured to said sub-frame of said rail, and inwardly facing sides of said vertical frame members of said rail receiving said panel therein to thereby from said door assembly.

20. The paneled door assembly according to claim 19, wherein said stiles and said rails are interconnected by fasteners.

21. The paneled door assembly according to claim 20, wherein said fasteners comprise dowels.

22. The paneled door assembly according to claim 20, wherein said stiles have hollow cores.

23. The paneled door assembly according to claim 22, further comprising at least one insert in each of said hollow cores of said stiles.

24. The paneled door assembly according to claim 23, wherein said inserts comprise at least one chosen from a group of corrugated cardboard and foam.

25. The paneled door assembly according to claim 20, wherein said rails have at least partially hollow cores.

26. The paneled door assembly according to claim 25, further comprising at least one insert in each of said hollow cores of said rails.

27. A paneled door assembly comprising:
a pair of stiles;
a pair of rails interconnecting said stiles;
at least one panel supported between said pair of stiles and said pair of rails;
each of said rails comprising a pair of spaced apart generally vertical frame members, a pair of generally horizontal frame members interconnected with said vertical frame members to form a sub-frame, and door skins mounted over said sub-frame and secured to said sub-frame, and inwardly facing sides of said horizontal frame members receiving said panel therein; and
each of said stiles comprising a pair of spaced apart generally vertical frame members, a pair of generally horizontal frame members interconnected with said vertical frame members of said stiles to form a sub-frame, and door skins mounted over and secured to said sub-frame of said stiles, and inwardly facing sides of said vertical frame members of said stiles receiving said panel therein to thereby from said door assembly.
